(19) United States
(12) Patent Application Publication
(10) Pub. No.: US 2025/0286987 A1
(43) Pub. Date: Sep. 11, 2025

(54) ELECTRONIC APPARATUS AND METHOD FOR CONTROLLING THEREOF

(71) Applicant: SAMSUNG ELECTRONICS CO., LTD., Suwon-si (KR)

(72) Inventors: Seungho PARK, Suwon-si (KR); Daesung CHO, Suwon-si (KR); Younghoon JEONG, Suwon-si (KR)

(73) Assignee: SAMSUNG ELECTRONICS CO., LTD., Suwon-si (KR)

(21) Appl. No.: 19/040,303

(22) Filed: Jan. 29, 2025

Related U.S. Application Data
(63) Continuation of application No. PCT/KR2024/096980, filed on Dec. 13, 2024.

(30) Foreign Application Priority Data
Mar. 5, 2024 (KR) 10-2024-0031074

(51) Int. Cl. H04N 13/268; G06T 3/18; G06T 5/50; G06T 5/77; G06T 7/13; G06T 7/40; G06T 7/50

(52) U.S. Cl. CPC H04N 13/268; G06T 3/18; G06T 5/50; G06T 5/77; G06T 7/13; G06T 7/40; G06T 7/50; G06T 2207/20081

(57) ABSTRACT

An electronic apparatus is disclosed. The electronic apparatus includes memory storing one or more instructions, and at least one processor configured to execute the one or more instructions, with the one or more instructions, when executed by the at least one processor, cause the electronic apparatus to: based on a depth map corresponding to an input image, identify a plurality of object regions included in the input image, identify hole-filling complexity for hole regions that are generated in boundary regions among the plurality of object regions, identify a view of an image of a novel view based on the hole-filling complexity, and obtain the image of the novel view based on the view.

### CROSS-REFERENCE TO RELATED APPLICATION(S)

This application is a bypass continuation of International Application No. PCT/KR2024/096980, filed on Dec. 13, 2024, which is based on and claims priority to Korean Patent Application No. 10-2024-0031074, filed on Mar. 5, 2024, in the Korean Intellectual Property Office, the disclosures of which are incorporated by reference herein in their entireties.

### BACKGROUND

### 1. Field

The disclosure relates to an electronic apparatus and a method for controlling thereof, and more particularly, to an electronic apparatus that generates an image of a novel view, and a method for controlling thereof.

### 2. Description of the Related

Spurred by the development of electronic technologies, various types of electronic apparatuses are being developed and distributed. In particular, display apparatuses used in various places such as homes, offices, public spaces, etc. are continuously developing in recent few years.

Stereoscopy is a three-dimensional technology. Commercialization of three-dimensional (3D) display is being promoted, mainly using binocular disparity. A binocular disparity method has an advantage that a stereoscopic effect can be formed on a single screen such as a TV screen or a cinema screen. A method of using binocular disparity is divided into a stereoscopic method of using a subsidiary tool such as glasses, etc., and an auto-stereoscopic method.

Recently, commercialization for a light field display by an auto-stereoscopic method and an auto-stereoscopic 3D display utilizing eye-tracking is being continuously studied. Also, not only in the aspect of a display, but also a study for converting a conventional two-dimensional (2D) image into a 3D image and thereby enabling consumers to experience various 3D images is also continuously going on.

### SUMMARY

An electronic apparatus according to an embodiment of the disclosure includes memory storing one or more instructions, and at least one processor configured to execute the one or more instructions, with the one or more instructions, when executed by the at least one processor, cause the electronic apparatus to: based on a depth map corresponding to an input image, identify a plurality of object regions included in the input image, identify hole-filling complexity for hole regions that are generated in boundary regions among the plurality of object regions, identify a view of an image of a novel view based on the hole-filling complexity, and obtain the image of the novel view based on the view.

A method for controlling an electronic apparatus according to an embodiment of the disclosure may include the based on a depth map corresponding to an input image, identifying a plurality of object regions included in the input image; identifying hole-filling complexity for hole regions that are generated in boundary regions among the plurality of object regions; and identifying a view of an image of a novel view based on the hole-filling complexity, and obtaining the image of the novel view based on the identified view.

In a non-transitory computer-readable medium storing computer instructions that, when executed by a processor of an electronic apparatus, cause the electronic apparatus to perform operations including based on a depth map corresponding to an input image, identifying a plurality of object regions included in the input image; identifying hole-filling complexity for hole regions that are generated in boundary regions among the plurality of object regions; and identifying a view of an image of a novel view based on the hole-filling complexity, and obtaining the image of the novel view based on the identified view.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for illustrating a technology of generating an image of a novel view according to an embodiment;

FIG. 2A is a block diagram illustrating a configuration of an electronic apparatus according to an embodiment;

FIG. 2B is a block diagram illustrating in detail a configuration of an electronic apparatus according to an embodiment;

FIG. 3 is a diagram for illustrating a configuration of and an operation of a display according to an embodiment;

FIG. 4 is a flow chart for illustrating a method for controlling an electronic apparatus according to an embodiment;

FIG. 5A is a diagram for illustrating a method of identifying hole-filling complexity according to an embodiment;

FIG. 5B is a diagram for illustrating a method of identifying hole-filling complexity according to an embodiment;

FIG. 5C is a diagram for illustrating a method of identifying hole-filling complexity according to an embodiment;

FIG. 6 is a diagram for illustrating a method for controlling an electronic apparatus according to an embodiment;

FIG. 7 is a diagram for illustrating a method for controlling an electronic apparatus according to an embodiment;

FIG. 8 is a diagram for illustrating a method for controlling an electronic apparatus according to an embodiment;

FIG. 9 is a diagram for illustrating a method for controlling an electronic apparatus according to an embodiment;

FIG. 10 is a diagram for illustrating in detail a method of providing a 3D image according to an embodiment;

FIG. 11A is a diagram for illustrating a method of obtaining information by using an artificial intelligence model according to an embodiment;

FIG. 11B is a diagram for illustrating a method of obtaining information by using an artificial intelligence model according to an embodiment;

FIG. 12A is a diagram for illustrating a method of generating an image of a novel view according to an embodiment;

FIG. 12B is a diagram for illustrating a method of generating an image of a novel view according to an embodiment;

FIG. 12C is a diagram for illustrating a method of generating an image of a novel view according to an embodiment;

FIG. 13A is a diagram for illustrating a method of generating an image of a novel view according to an embodiment;

FIG. 13B is a diagram for illustrating a method of generating an image of a novel view according to an embodiment;

FIG. 13C is a diagram for illustrating a method of generating an image of a novel view according to an embodiment;

FIG. 13D is a diagram for illustrating a method of generating an image of a novel view according to an embodiment;

FIG. 13E is a diagram for illustrating a method of generating an image of a novel view according to an embodiment;

FIG. 14A is a diagram for illustrating a method of generating an image of a novel view according to an embodiment;

FIG. 14B is a diagram for illustrating a method of generating an image of a novel view according to an embodiment;

FIG. 14C is a diagram for illustrating a method of generating an image of a novel view according to an embodiment;

FIG. 14D is a diagram for illustrating a method of generating an image of a novel view according to an embodiment;

FIG. 14E is a diagram for illustrating a method of generating an image of a novel view according to an embodiment;

FIG. 15A is a diagram for illustrating a method of generating an image of a novel view according to an embodiment;

FIG. 15B is a diagram for illustrating a method of generating an image of a novel view according to an embodiment;

FIG. 15C is a diagram for illustrating a method of generating an image of a novel view according to an embodiment;

FIG. 16A is a diagram for illustrating a method of generating an image of a novel view according to an embodiment; and

FIG. 16B is a diagram for illustrating a method of generating an image of a novel view according to an embodiment.

### DETAILED DESCRIPTION

First, terms used in this specification will be described briefly, and then the disclosure will be described in detail.

As terms used in the embodiments of the disclosure, general terms that are currently used widely were selected as far as possible, in consideration of the functions described in the disclosure. However, the terms may vary depending on the intention of those skilled in the art who work in the pertinent field or previous court decisions, or emergence of new technologies, etc. Further, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including only A, (2) including only B, or (3) including both of A and B.

Further, the expressions “first,” “second,” and the like used in this specification may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that an apparatus is “specifically designed to” in terms of hardware.

Instead, under some circumstances, the expression “an apparatus configured to” may mean that the apparatus “is capable of” performing an operation together with another apparatus or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Also, singular expressions include plural expressions, as long as they do not obviously mean differently in the context. In addition, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the embodiments, “a module” or “a unit” may perform at least one function or operation, and may be implemented as hardware or software, or as a combination of hardware and software. Further, a plurality of “modules” or “units” may be integrated into at least one module and implemented as at least one processor (not shown), excluding “a module” or “a unit” that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

Hereinafter, an embodiment of the disclosure will be described in more detail with reference to the accompanying drawings.

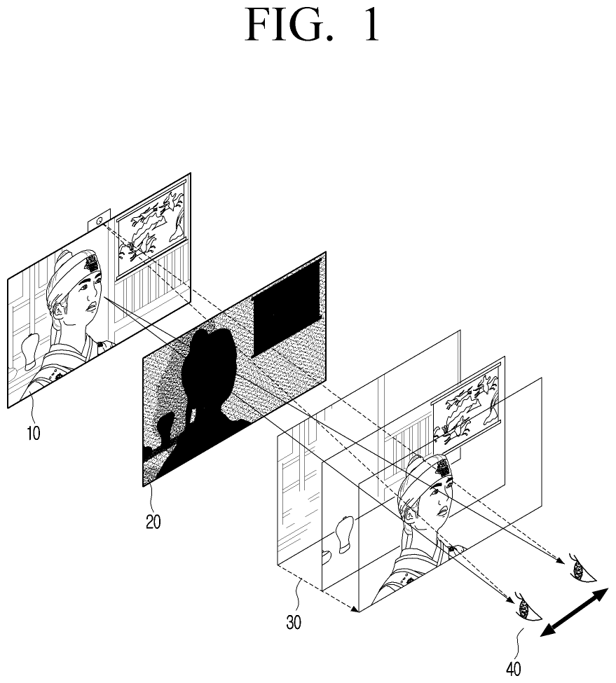

FIG. 1 is a diagram for illustrating a technology of generating an image of a novel view according to an embodiment.

A technology of generating a novel view image (novel view synthesis) is a technology of generating, from a 2D image obtained through a monocular camera, an image of a novel view different from the view in the 2D image.

Referring to FIG. 1 according to an embodiment, for obtaining a 3D image from a 2D image, a depth map 20 may be obtained by estimating depth from a 2D image which is an input image 10, and a binocular image may be obtained (40) by controlling (30) the depth of each object according to the obtained depth map 20.

According to an embodiment, for obtaining a 3D image from a 2D image, view synthesis (or novel view synthesis) may be performed. View synthesis means a technology of inferring and generating an image of a novel view from an image photographed on a specific time point.

For example, according to view synthesis, a binocular image may be obtained by i) generating a novel right eye image using a left eye image as input image, or ii) generating a novel left eye image by using a right eye image as input image, or iii) generating a novel left eye image and a novel right eye image based on an input image.

When generating a novel view image as described above, as pixel values may be artificially generated for a hole region (or an occlusion region or point region) of the novel view image and be used to fill the hole region, the region may look unnatural. A hole region may be a region that is not exposed in a foreground region on the current time point, i.e., in an input image, but is exposed when the time point is moved, i.e., in a novel view image.

Hereinafter, various embodiments of obtaining a binocular image wherein there are few side effects and which is natural, by generating an image of a novel view advantageous for hole-filling by analyzing an input image will be explained.

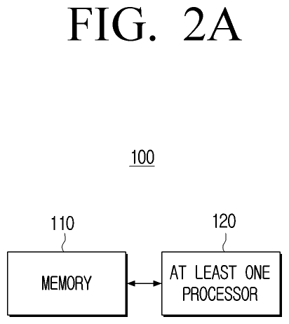

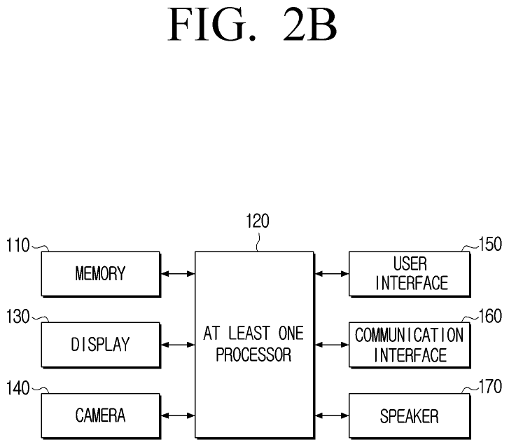

FIG. 2A is a block diagram illustrating a configuration of an electronic apparatus according to an embodiment.

According to FIG. 2A, the electronic apparatus 100 includes memory 110 and at least one processor 120.

The electronic apparatus 100 may be implemented as display apparatuses in various types such as a TV, a monitor, a PC, a kiosk, a tablet PC, an electronic photo frame, a mobile phone, a head mounted display (HMD), a near eye display (NED), a large format display (LFD), digital signage, a digital information display (DID), a video wall, a projector display etc., or an image processing apparatus that provides images to a display apparatus (e.g., a set-top box, a one connected box).

The memory 110 may store data necessary for the various embodiments of the disclosure. The memory 110 may be implemented in the form of memory embedded in the electronic apparatus 100, or implemented in the form of memory that can be attached to or detached from the electronic apparatus 100 according to the usage of stored data. For example, in the case of data for operating the electronic apparatus 100, the data may be stored in memory embedded in the electronic apparatus 100, and in the case of data for an extended function of the electronic apparatus 100, the data may be stored in memory that can be attached to or detached from the electronic apparatus 100. Meanwhile, in the case of memory embedded in the electronic apparatus 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that can be attached to or detached from the electronic apparatus 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.) and external memory that can be connected to a USB port (e.g., a USB memory), etc.

According to an embodiment, the memory 110 may store one or more instructions or a computer program including instructions for controlling the electronic apparatus 100.

According to another embodiment, the memory 110 may store an image received from an external apparatus (e.g., a source apparatus), an external storage medium (e.g., a USB), an external server (e.g., a webhard), etc., i.e., an input image. Alternatively, the memory 110 may store an image obtained through a camera included in the electronic apparatus 100. Here, the image may be a 2D video, but is not limited thereto.

According to still another embodiment, the memory 110 may store various types of information necessary for image quality processing, e.g., information, an algorithm, an image quality parameter, etc. for performing at least one of noise reduction, detail enhancement, tone mapping, contrast enhancement, color enhancement, or frame rate conversion. Also, the memory 110 may store an intermediate image generated by image processing, and an image generated based on depth information.

According to an embodiment, the memory 110 may be implemented as single memory that stores data generated in various operations according to the disclosure. However, according to another embodiment, the memory 110 may also be implemented to include a plurality of memories that respectively store different types of data, or respectively store data generated in different steps.

In the aforementioned embodiment, it was explained that various types of data are stored in the external memory 110 of the processor 120, but at least some of the aforementioned data may be stored in internal memory of the processor 120 according to at least one implementation example of the electronic apparatus 100 or the processor 120.

The at least one processor 120 controls the overall operations of the electronic apparatus 100. Specifically, the at least one processor 120 may be connected with each component of the electronic apparatus 100, and control the overall operations of the electronic apparatus 100. For example, the at least one processor 120 may be operatively connected with the memory 110, and control the overall operations of the electronic apparatus 100. The at least one processor 120 may consist of one or a plurality of processors.

The at least one processor 120 may perform the operations of the electronic apparatus 100 according to various embodiments by executing the one or more instructions stored in the memory 110.

The at least one processor 120 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 120 may control one or a random combination of the other components of the electronic apparatus, and perform an operation related to communication or data processing. Also, the at least one processor 120 may execute one or more programs or instructions stored in the memory. For example, the at least one processor 120 may perform the method according to an embodiment the disclosure by executing the one or more instructions stored in the memory.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 120 may be implemented as a single core processor including one core, or may be implemented as one or more multicore processors including a plurality of cores (e.g., multicores of the same kind or multicores of different kinds). In case the at least one processor 120 is implemented as multicore processors, each of the plurality of cores included in the multicore processors may include internal memory of the processor such as cache memory, on-chip memory, etc., and a common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor may mean a system on chip (SoC) with at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto. Hereinafter, the at least one processor 120 will be referred to as the processor 120, for the convenience of explanation.

According to an embodiment, the electronic apparatus 100 may receive various compressed images or images of various resolutions. For example, the electronic apparatus 100 may receive images in compressed forms such as moving picture experts group (MPEG) (e.g., MP2, MP4, MP7, etc.), joint photographic coding experts group (JPEG), advanced video coding (AVC), H.264, H.265, high efficiency video codec (HEVC), etc. Alternatively, the electronic apparatus 100 may receive any one image among a standard definition (SD) image, a high definition (HD) image, a full HD image, and an ultra HD image.

According to an embodiment, the processor 120 may obtain depth information from an input image. Here, the input image may include a still image, a plurality of continuous still images (or frames), or a video. For example, the input image may be a 2D image.

The depth information may be in a form of a depth map. A depth map indicates 3D distance information of an object existing in an image, and it may be granted for each pixel of an image. According to an embodiment, depth of 8Bit may have a grayscale value from 0 to 255. For example, when indicating based on black/white colors, a black color (a low value) may indicate a place far from a viewer, and a white color (a high value) may indicate a place close to a viewer. However, this is merely an example, and a depth map may be expressed as various values according to various standards.

According to an embodiment, the processor 120 may obtain a depth map from a 2D input image based on a depth estimation algorithm, a formula, a trained artificial intelligence model, etc. For example, an artificial intelligence model may be implemented as a neural network including a plurality of neural network layers. An artificial intelligence model may be implemented as a deep neural network (DNN), a convolutional neural network (CNN), a recurrent neural network (RNN), a restricted Boltzmann Machine (RBM), a deep belief network (DBN), a bidirectional recurrent deep neural network (BRDNN), or deep Q-networks, etc., but is not limited thereto.

According to an embodiment, the processor 120 may perform image processing of an input image, and then obtain depth information based on the image that went through image processing. Here, the image processing may be digital image processing including at least one of image enhancement, image restoration, image transformation, image analysis, image understanding, image compression, image decoding, or image scaling.

According to an embodiment, various kinds of pre-processing may be performed before obtaining depth information for an input image, but hereinafter, an input image and a pre-processed image may be referred to as an input image without being divided, for the convenience of explanation.

In this specification, “a region” is a term that refers to a portion of an image. It may mean at least one pixel block or a collection of pixel blocks. Also, a pixel block may mean a collection of adjacent pixels including at least one pixel.

The processor 120 may store depth information corresponding to an image input, e.g., a depth map in the memory 110. According to an embodiment, when a first frame and a second frame are sequentially input, the processor 120 may apply pre-processing and/or post-processing to the first frame and the second frame, and sequentially obtain a first depth map and a second depth map corresponding to the first frame and the second frame, and store them in the memory 110. For example, the first frame and the second frame may be 2D monocular image frames. The first frame and the second frame are frames constituting a video, and if the second frame is a frame which is currently the subject for processing, the first frame may be a frame that was previously processed. For example, in case the video is a real time streaming image, the first frame may be a frame that was streamed before the second frame. However, the disclosure is not limited thereto, and the first frame may be a frame that is before the second frame by a predetermined frame interval (e.g., a two frame interval). Hereinafter, for the convenience of explanation, the first and second frames will respectively be referred to as a previous frame and a current frame.

According to an embodiment, the processor 120 may obtain a depth map of the first frame and the second frame based on various image processing methods, e.g., an algorithm, a formula, an artificial intelligence model, etc.

According to an embodiment, the processor 120 may identify hole-filling complexity for hole regions that are generated in boundary regions among a plurality of object regions.

According to an embodiment, the processor 120 may identify a view of a novel view image based on the hole-filling complexity, and obtain the novel view image based on the identified view. For example, the processor 120 may identify the hole-filling complexity based on the sizes of the holes and the complexity of the hole-filling context.

According to an embodiment, the processor 120 may identify the hole-filling complexity for the hole regions based on at least one of the complexity of the boundary regions (referred to as boundary complexity hereinafter), the sizes of the holes generated in the boundary regions, or the complexity of reference regions for filling the holes.

According to an embodiment, the processor 120 may obtain the novel view image based on a view for which the hole-filling complexity is relatively low, where the novel view is based on a view from among a right eye view or a left eye view.

According to an embodiment, the processor 120 may obtain the novel view image based on the same view in a unit of a predetermined frame section. For example, the unit of the predetermined frame section may include one frame unit or one scene unit.

According to an embodiment, the processor 120 may analyze hole-filling complexity in a frame unit, and obtain a novel view image according to the analysis result. For example, the processor 120 may analyze hole-filling complexity for the first frame and obtain a right eye image as a novel view image by using the first frame as a left eye image. The processor 120 may analyze hole-filling complexity for the second frame and obtain a left eye image as the novel view image by using the second frame as a right eye image. The processor 120 may also analyze hole-filling complexity for the third frame and obtain a right eye image of the third frame as the novel view image by using the third frame as a left eye image.

According to an embodiment, the processor 120 may analyze hole-filling complexity in a scene unit (e.g., multiple frames that make up a scene), and obtain a novel view image according to the analysis result. For example, if a novel view image is identified by analyzing hole-filling complexity for the first frame included in a scene, the processor 120 may obtain the novel view image by applying the same novel view to all frames included in the scene. However, the first frame in a scene is merely an example, and a frame for determining a novel view image in one scene does not necessarily have to be the first frame. For example, a novel view to be applied in one scene may be identified by various methods such as generating a lot of novel views (e.g., a left eye view and a right eye view) for each of a plurality of frames in a scene. Generating a novel view image based on the same view in one scene as above may be appropriate for non-real time conversion, but it will be understood that the disclosure is not limited thereto.

According to another embodiment, the processor 120 may generate an effective novel view image in a frame unit in one scene. For example, in the case of generating a novel view image based on views identified for each frame in one scene, the processor 120 may generate a novel view image such that the view changes smoothly and continuously among continuous frames through filtering. According to an embodiment, the processor 120 may generate a novel view image such that the view changes smoothly among continuous frames through an infinite impulse response (IIR) filter or a finite impulse response (FIR) filter. For example, a form with a depth map is an 8bit map, and 127 (or 128) among grayscale values from 0 to 255 included in the bit map is used as a reference value, i.e., 0 (or a focal plane), and values smaller than 127 are indicated as − values, and values bigger than 127 are indicated as + values may be implemented. For example, a case where, as the hole-filling complexity of each frame is analyzed, for the first frame − an average depth value corresponding to a right eye image is 5, and an average depth value corresponding to a left eye image is −5; for the second frame − an average depth value corresponding to a right eye image is 4, and an average depth value corresponding to a left eye image is −5, and for the third frame-an average depth value corresponding to a right eye image obtained is 3, and an average depth value corresponding to a left eye image is −4. In this case, the processor 120 may obtain a final binocular image corresponding to the first frame, the second frame, and the third frame based on depth values such as (5, −5), (4, −6), (3, −7), etc. or (5, −5), (6, −4), (7, −3) by using the IIR. For example, the processor 120 may obtain a binocular image where the view changes smoothly while the depth difference of the binocular image corresponding to each frame is maintained by applying the IIR to the plurality of frames included in each scene. Generating a novel view image by identifying an effective view for each frame in one scene may be appropriate for real time conversion, but the disclosure is not limited thereto.

FIG. 2B is a block diagram illustrating in detail a configuration of an electronic apparatus according to an embodiment.

According to FIG. 2B, the electronic apparatus 100′ may include memory 110, at least one processor 120, a display 130, a camera 140, a user interface 150, a communication interface 160, and a speaker 170. Among the components illustrated in FIG. 2B, it will be understood that components may overlap with the components illustrated in FIG. 2A, and accordingly, detailed explanation will be omitted.

The display 130 may be implemented as a display including self-luminous diodes or a display including non-self-luminous diodes and a backlight. For example, the display 130 may be implemented as various forms of displays such as a liquid crystal display (LCD), an organic light-emitting diodes (OLED) display, a light-Emitting diodes (LED) display, a micro LED, a mini LED, a plasma display panel (PDP), a quantum dot (QD) display, a quantum dot light-emitting diodes (QLED) display, etc. In the display 130, driving circuits that may be implemented in forms such as an a-si TFT, a low temperature poly silicon (LTPS) TFT, an organic TFT (OTFT), etc., and a backlight unit, etc. may also be included. According to an embodiment, on the front surface of the display 130, a touch sensor that is in a form such as a touch film, a touch sheet, a touch pad, etc., and detects a touch operation may be arranged, and implemented to detect various types of touch inputs. For example, the display 130 may detect various types of touch inputs such as a touch input by a user hand, a touch input by an input device such as a stylus pen, a touch input by a specific electrostatic material, etc. Here, an input device may be implemented as an input device of a pen type that can be referred to as various terms such as an electronic pen, a stylus pen, an S-pen, etc. According to an embodiment, the display 130 may be implemented as a flat display, a curved display, a flexible display that can be folded and/or rolled, etc.

According to an embodiment, the display 130 may provide an output image consisting of a binocular image including at least one novel view image.

The camera 140 may be turned on according to a predetermined event, and perform photographing. The camera 140 may convert a photographed image into an electric signal, and generate image data based on the converted signal. For example, a subject may be converted into an electric image signal through a semiconductor optical element (a charge coupled device (CCD)), and the image signal converted as such may be amplified and converted into a digital signal, and then go through signal processing. For example, the camera 140 may include at least one of a general (basic) camera or a super wide angle camera.

According to an embodiment, the camera 140 may obtain a user photographed image, and provide it to the processor 120. The processor 120 may detect the location of the user's face from the user photographed image, and identify the user's eyes in the user's face, and obtain gazes information of the user in real time. The processor 120 may obtain an output image by rearranging a binocular image based on the real time gaze information (or eye tracking information) of the user.

As a method of detecting a facial region, various conventional methods may be used. Specifically, a direct recognition method and a method using statistics may be used. In the direct recognition method, rules using physical characteristics such as the contour skin color of a facial image and the sizes of components or the distance between each other, etc. are made, and comparison, inspection, and measurement are performed according to the rules. In the method using statistics, a facial region may be detected according to an algorithm that was learned in advance. That is, it is a method of making unique characteristics included in an input face as data, and performing comparative analysis with a prepared database of a large amount (the shapes of the face and other objects). In particular, a facial region may be detected according to an algorithm that was learned in advance, and a method such as a multi-layer perceptron (MLP) and a support vector machine (SVM) may be used. By a method similar to this, the user's eye regions may be identified.

The user interface 150 may be implemented as a device such as a button, a touch pad, a mouse, and a keyboard, or implemented as a touch screen, etc. that can perform both the aforementioned display function and a manipulation input function.

The communication interface 160 can obviously be implemented as various interfaces depending on implementation examples of the electronic apparatus 100′. For example, the communication interface 160 may perform communication with an external apparatus, an external storage medium (e.g., a USB memory), an external server (e.g., a webhard), etc. through communication methods such as Bluetooth, AP-based Wi-Fi (Wi-Fi, a wireless LAN network), Zigbee, a wired/wireless local area network (LAN), a wide area network (WAN), an Ethernet, the IEEE 1394, a high-definition multimedia interface (HDMI), a universal serial bus (USB), a mobile high-definition link (MHL), the Audio Engineering Society/European Broadcasting Union (AES/EBU), Optical, Coaxial, etc. According to an embodiment, the communication interface 160 may perform communication with another electronic apparatus, an external server, and/or a remote control apparatus, etc.

The speaker 170 may be a component that outputs not only various kinds of audio data but also various kinds of notification sounds or voice messages, etc. The processor 130 may control the speaker 170 to output feedbacks or various kinds of notifications according to the various embodiments of the disclosure in audio forms.

Other than the above, the electronic apparatus 100′ may include a sensor and a microphone, etc. depending on implementation examples.

The sensor may include various types of sensors such as a touch sensor, a proximity sensor, an acceleration sensor (or a gravity sensor), a geomagnetic sensor, a gyro sensor, a pressure sensor, a position sensor, a distance sensor, an illumination sensor, etc.

The microphone is a component for receiving inputs of user voices or other sounds, and converting them into audio data. However, according to another embodiment, the electronic apparatus 100′ may receive a user voice input through an external apparatus through the communication interface 160.

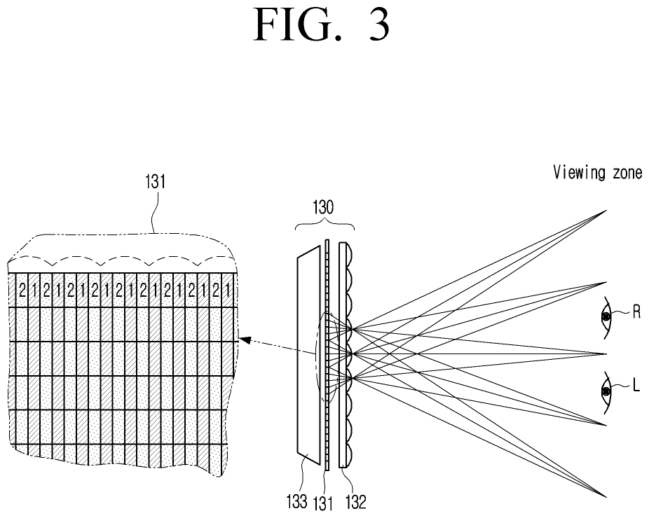

FIG. 3 is a diagram for illustrating a configuration and an operation of the display 130 according to an embodiment.

According to FIG. 3, the display 130 may include a display panel 131, a viewing zone separation unit 132, and a backlight unit 133. However, depending on implementation examples of the display 130, the backlight unit 133 may not be included in the display 130.

The display panel 131 includes a plurality of pixels consisting of a plurality of sub-pixels. Here, the sub-pixels may consist of a red (R) sub-pixel, a green (G) sub-pixel, and a blue (B) sub-pixel. For example, pixels consisting of R, G, B sub-pixels may be arranged in a plurality of row and column directions, and constitute the display panel 131.

The display panel 131 displays a binocular view image (or a multi-view image). For example, the display panel 131 may display an image where a plurality of images of a right eye image and a left eye image are sequentially arranged.

The viewing zone separation unit 132 may be arranged on the front surface of the display panel 131, and provide different views, e.g., a multi-view for each viewing zone. In this case, the viewing zone separation unit 132 may be implemented as a lenticular lens, or a parallax barrier. As an example, the viewing zone separation unit 132 may be implemented as a lenticular lens including a plurality of lens regions. Accordingly, a lenticular lens may refract an image displayed on the display panel 131 through the plurality of lens regions. Each lens region may be formed in a size corresponding to at least one pixel, and disperse lights penetrating each pixel differently for each viewing zone. As another example, the viewing zone separation unit 132 may be implemented as a parallax barrier. The parallax barrier is implemented as a transparent slit array including a plurality of barrier regions. Accordingly, lights may be blocked through the slits among the barrier regions, and images of different views for each viewing zone may thereby be made to be output.

According to an embodiment, the viewing zone separation unit 132 may operate while being tilted by a specific angle for improving image quality. In this case, the processor 130 may divide a right eye image and a left eye image based on the angle by which the viewing zone separation unit 132 is tilted, and combine them and generate a multi-view image. Accordingly, the user gets to view an image that is displayed to have a specific tilt with respect to the sub-pixels, but does not view an image that is displayed in a vertical direction or a horizontal direction with respect to the sub-pixels of the display panel 131.

According to an embodiment, the viewing zone separation unit 132 may be implemented as a lenticular lens array as illustrated in FIG. 3.

According to FIG. 3, the display panel 131 includes a plurality of pixels divided into a plurality of columns. For each column, images of different views, e.g., a left eye image and a right eye image may alternatingly be arranged. For example, as illustrated in FIG. 3, a left eye image and a right eye image 1, 2 may be sequentially arranged repetitively.

The backlight unit 133 provides lights to the display panel 131. By lights provided from the backlight unit 133, the left eye image and the right eye image 1, 2 formed on the display panel 131 may be projected to the viewing zone separation unit 132, and the viewing zone separation unit 132 may disperse the lights of each of the projected images 1, 2, and transmit them in the direction of the viewer. For example, the viewing zone separation unit 132 may generate exit pupils in the location of the viewer, i.e., the viewing distance. As illustrated in FIG. 3, the thickness and the diameter of the lenticular lens in case the viewing zone separation unit 132 is implemented as a lenticular lens array, and the interval of the slits in case the viewing zone separation unit 132 is implemented as a parallax barrier, etc. may be designed such that exit pupils generated by each column are separated by an average binocular center distance of smaller than 65 mm. The separated lights may respectively form a viewing region.

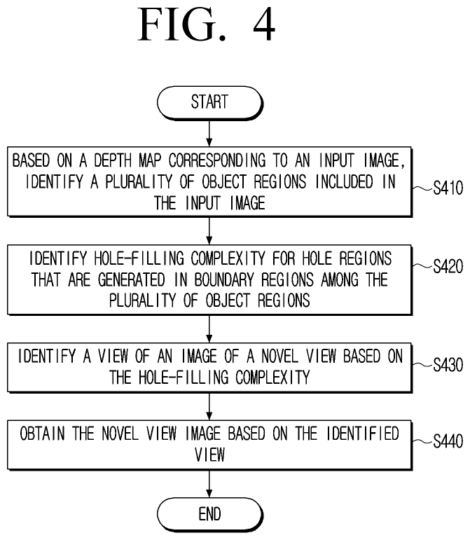

FIG. 4 is a flow chart for illustrating a method for controlling an electronic apparatus according to an embodiment.

According to FIG. 4, in operation 410, the electronic apparatus 100 may, based on a depth map corresponding to an input image, identify a plurality of object regions included in the input image.

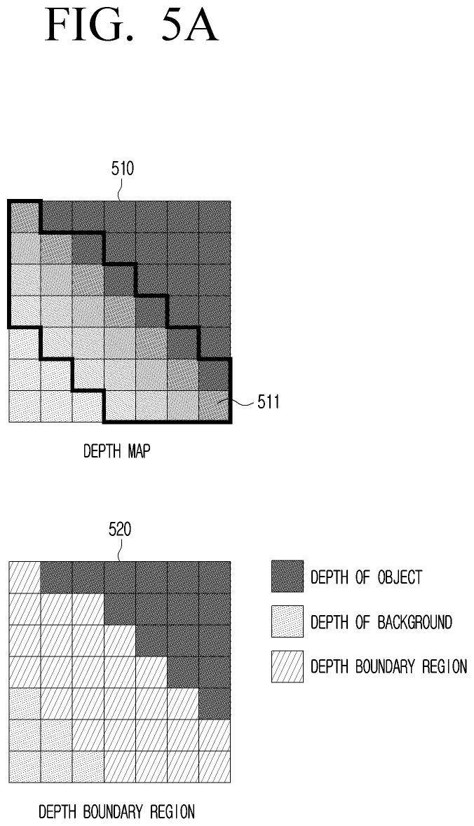

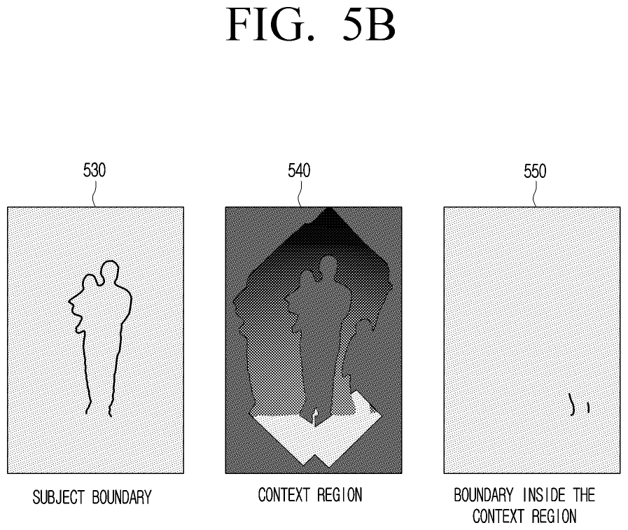

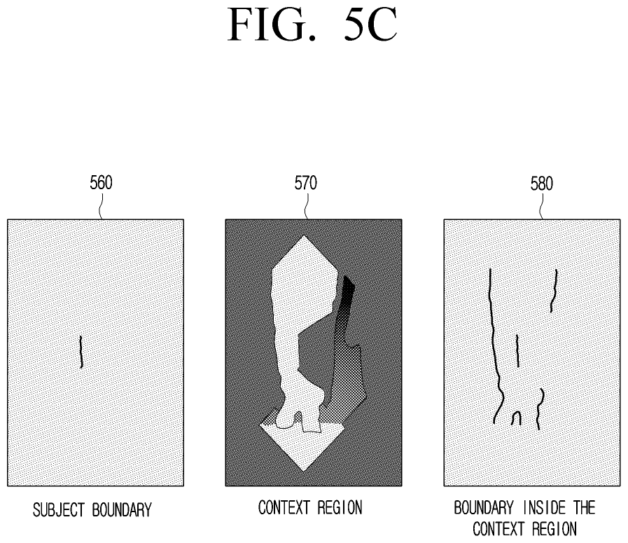

For example, the electronic apparatus 100 may use a depth value difference with a neighboring pixel for determining objects and a background in a depth map or boundary regions of two objects. For example, the electronic apparatus 100 may define a pixel that has a depth difference from a center pixel among four neighboring pixels in up, down, left, and right directions is greater than or equal to a specific numerical value as a depth boundary region. For example, as illustrated in FIG. 5A, in the depth map 510, a region 511 including a pixel that has a depth difference from a center pixel among four neighboring pixels in up, down, left, and right directions is greater than or equal to a specific numerical value may be identified as a depth boundary region (520).

According to an embodiment, the electronic apparatus 100 may identify a boundary region of an object in the depth map, and then identify the size of the object through a morphological operation. For example, the electronic apparatus 100 may identify an object region included in an input image through at least one technology among object recognition, object detection, object tracking, or image segmentation. For instance, the electronic apparatus 100 may identify an object region by using technologies such as semantic segmentation of dividing objects included in an input image into each type and extracting the objects, instance segmentation of dividing even objects of the same type into each object and recognizing the objects, a bounding box of a rectangular form including a detected object when detecting an object included in an image, etc. depending on needs.

In operation 420, the electronic apparatus 100 may identify the hole-filling complexity for hole regions (or occlusion regions) generated in the boundary regions among the plurality of object regions. A hole region may be a region that is not exposed in a foreground region on the current time point, i.e., in an input image, but is exposed when the time point is moved, i.e., in a novel view image. For example, the electronic apparatus 100 may set hole regions for each boundary region among the objects extracted from the depth map.

According to an embodiment, the electronic apparatus 100 may identify the hole-filling complexity for the hole regions based on at least one of the boundary complexity, the sizes of the holes generated in the boundary regions, or the complexity of reference regions for filling the holes.

For example, the boundary complexity may include density information of objects. For instance, in case a plurality of objects are jumbled around boundaries, the boundaries among the objects get to be dense. Due to this, the hole regions may be excessively set or unnecessary information may be included in context regions (regions adjacent to the hole regions), and thus the probability that an unstable result would be generated when filling the hole regions may increase. A context region may be a region adjacent to an occlusion region. For example, a context region may be used as a reference region for filing a hole region. For instance, the electronic apparatus 100 may identify boundary complexity based on the number of neighboring boundaries included in a context region. For instance, the electronic apparatus 100 may initialize an occlusion region within a designated range and a context region corresponding thereto based on a subject boundary, and define the number of boundaries that exist in the initial context region as the boundary complexity. For example, as illustrated in FIG. 5B, a context region may be identified (540) based on an image 530 indicating a subject boundary, and two boundaries may be identified in the context region based on an image 550 indicating boundaries in the context region. Accordingly, the boundary complexity may be identified as 2. For example, as illustrated in FIG. 5C, a context region may be identified 570 based on a subject boundary 560, and five boundaries may be identified in the context region based on an image 580 indicating boundaries in the context region. Accordingly, the boundary complexity may be identified as 5. However, the feature of calculating the boundary complexity illustrated in FIG. 5B and FIG. 5C are merely an example, and the disclosure is not limited thereto, and boundary complexity can be calculated by various methods that can indicate boundary complexity.

According to an embodiment, the electronic apparatus 100 may calculate hole-filling complexity by applying the same weight, or applying different weights to the boundary complexity, the sizes of the holes, and the complexity of the reference regions. For example, the electronic apparatus 100 may apply a predetermined same weight or different weights to the boundary complexity, the sizes of the holes, and the complexity of the reference regions. For instance, the electronic apparatus 100 may apply a predetermined same weight or different weights to the boundary complexity, the sizes of the holes, and the complexity of the reference regions according to a type of an image. For instance, the electronic apparatus 100 may apply a predetermined same weight or different weights to the boundary complexity, the sizes of the holes, and the complexity of the reference regions based on characteristics of each frame section included in an image. For example, each frame section may include one frame unit or one scene unit.

In operation 430, the electronic apparatus 100 may identify a view of a novel view image based on the hole-filling complexity.

According to an embodiment, the electronic apparatus 100 may identify a view of a novel view image based on a view wherein the hole-filling complexity is relatively low with the view having relatively low hole-filing complexity being one or both of a right eye view or a left eye view.

In operation 440, the electronic apparatus 100 may obtain the novel view image based on the identified view.

According to an embodiment, if it is identified that hole-filling complexity of a right eye image is relatively lower compared to that of a left eye image, the electronic apparatus 100 may generate a right eye image as a novel view image. According to another embodiment, if it is identified that hole-filling complexity of a left eye image is relatively lower compared to that of a right eye image, the electronic apparatus 100 may generate a left eye image as a novel view image. According to still another embodiment, if it is identified that hole-filling complexity would be relatively low in the case of generating both a right eye image and a left eye image based on an input image, the electronic apparatus 100 may generate both a right eye image and a left eye image.

According to an embodiment, the electronic apparatus 100 may analyze hole-filling complexity in a frame unit, and obtain a novel view image according to the analysis result.

According to an embodiment, the electronic apparatus 100 may analyze hole-filling complexity in a scene unit, and obtain a novel view image according to the analysis result. For example, the electronic apparatus 100 may obtain a novel view image based on the same view inside the same scene, and when the scene is changed, the electronic apparatus 100 may obtain a novel view image based on a novel view.

As described above, according to characteristics such as a scene composition, etc. of an image, the sizes and complexity of hole regions that are generated when generating a left eye image or a right eye image vary, and thus generating a view where the hole sizes are relatively small and hole-filling is easy would be advantageous for generating a natural image.

Meanwhile, in FIG. 4, the order was mapped to all steps for the convenience of explanation, but it is obvious that the order of steps that are not related to an order or that can be performed in parallel, etc. is not necessarily limited to the order.

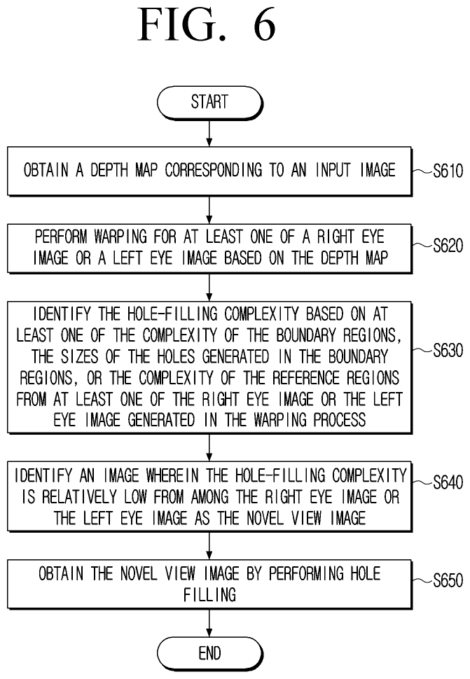

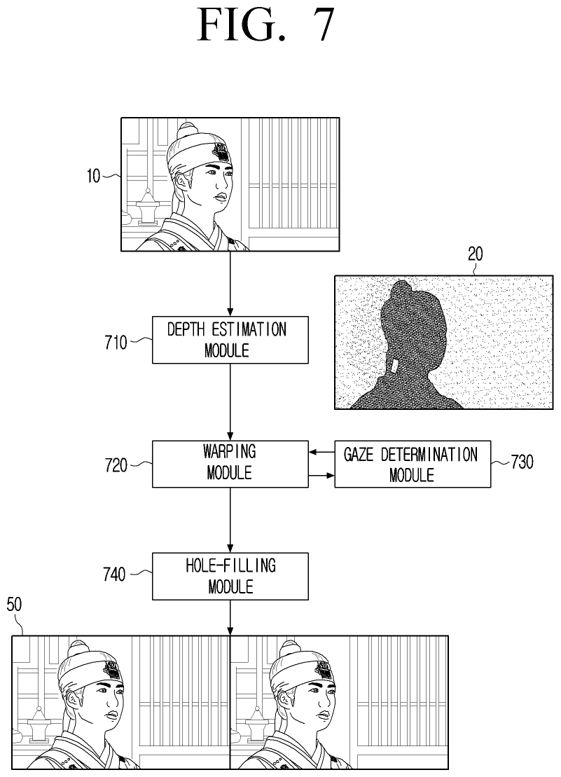

FIG. 6 and FIG. 7 are diagrams for illustrating a method for controlling an electronic apparatus according to an embodiment.

FIG. 6 is a flow chart for illustrating a method for controlling the electronic apparatus 100 according to an embodiment, and FIG. 7 is a block diagram for illustrating a method for controlling the electronic apparatus 100 according to an embodiment. According to FIG. 7, the electronic apparatus 100 may include a depth estimation module 710, a warping module 720, a view determination module 730 (also referred to as gaze determination module 720), and a hole-filling module 740. For example, each module may be implemented as at least one software or at least one hardware, and/or a combination thereof.

For example, at least one of the depth estimation module 710, the warping module 720, the view determination module 730, or the hole-filling module 740 may be implemented to use a pre-defined algorithm, a pre-defined formula and/or a trained artificial intelligence model. The depth estimation module 710, the warping module 720, the view determination module 730, and the hole-filling module 740 may be included in the electronic apparatus 100, but according to an embodiment, they may be dispersed in at least one external apparatus.

According to FIG. 6, in operation 610, the electronic apparatus 100 may obtain a depth map corresponding to an input image. According to an embodiment, the processor 130 may obtain a depth map by using the depth estimation module 710, and identify object regions included in the input image, e.g., a foreground region and a background region.

For example, the depth estimation module 710 may obtain a depth map according to a block matching-based method. In the block matching-based method, a block that will be used for search in the current image may be designated, and then a block having the most similar value to the block used for search in the previous image may be searched, and it may be determined as the same point, and depth information may be generated based on a difference in coordinate values between the block used for search and the searched block. However, the disclosure is not limited thereto, and a depth map may be obtained according to various methods that can estimate depth information.

For example, the depth estimation module 710 may identify object regions included in an input image, e.g., a foreground region and a background region based on a depth map, and perform warping. For instance, in one scene where there are two regions with adjoining boundary regions, a part that becomes a subject for perception may be referred to as the background, and the other parts may be referred to as the background. However, identification of a foreground region and a background region may also be performed through the warping module 720.

In operation 620, the electronic apparatus 100 may perform warping for at least one of a right eye image or a left eye image. According to an embodiment, the processor 130 may perform warping by using the warping module 720.

Warping means a technology of generating a novel view image, and by performing hole-filling for hole regions included in a warping image, a novel view image may be generated.

In operation 630, the electronic apparatus 100 may identify at least one of the boundary complexity, the sizes of the holes generated in the boundary regions, or the complexity of the reference regions from at least one of the right eye image or the left eye image generated in the warping process. According to an embodiment, the processor 130 may identify at least one of the boundary complexity, the sizes of the holes generated in the boundary regions, or the complexity of the reference regions from at least one of the right eye image or the left eye image generated in the warping process by using the view determination module 730.

According to an embodiment, the electronic apparatus 100 may identify sizes of holes by counting holes in a warping image generated in a warping process.

According to an embodiment, the electronic apparatus 100 may identify complexity of a reference region based on at least one of texture information or edge information corresponding to the reference region. The texture information means a unique pattern or shape of regions that are regarded as the same texture in an image. Edges in several forms exist in an image, and according to an embodiment, the edge information may include information on complex edges with diverse directions, and straight edges where directions are clear. In general, if a primary or secondary edge detection filter is applied to an input image, edge information including edge strength and edge direction information (a vertical direction to a gradient) may be obtained.

In operation 640, the electronic apparatus 100 may identify an image where the hole-filling complexity is relatively low from among the right eye image or the left eye image as the novel view image. According to an embodiment, the processor 130 may identify an image where the hole-filling complexity is relatively low from among the right eye image or the left eye image as the novel view image by using the view determination module 730. For example, as the sizes of the hole regions are bigger, the electronic apparatus 100 may determine that the hole-filling complexity is higher. For instance, if a reference region includes complex texture and/or a complex pattern, the electronic apparatus 100 may determine that the hole-filling complexity compared to a plane is high.

In operation 650, the electronic apparatus 100 may obtain the novel view image identified in operation 630. According to an embodiment, the processor 130 may generate the novel view image by performing hole filling for the hole regions included in the processed warping image by using the hole filling module 740.

Meanwhile, in FIG. 6, the order was mapped to all steps for the convenience of explanation, but it is obvious that the order of steps that are not related to an order or that can be performed in parallel, etc. is not necessarily limited to the order.

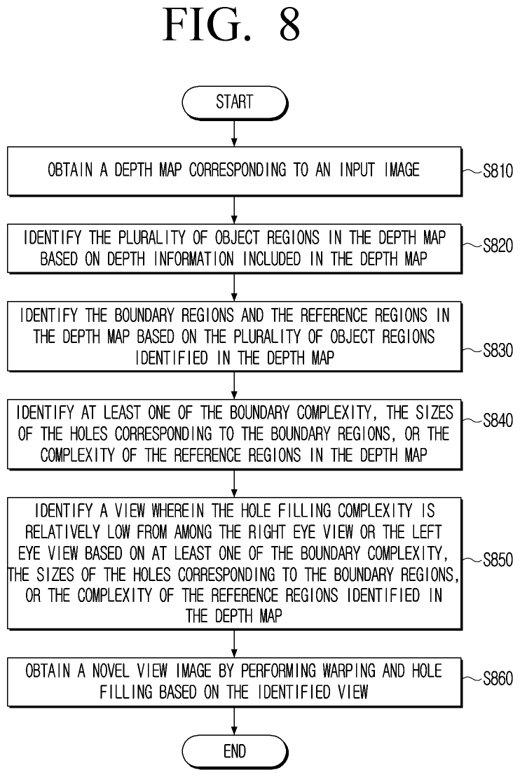

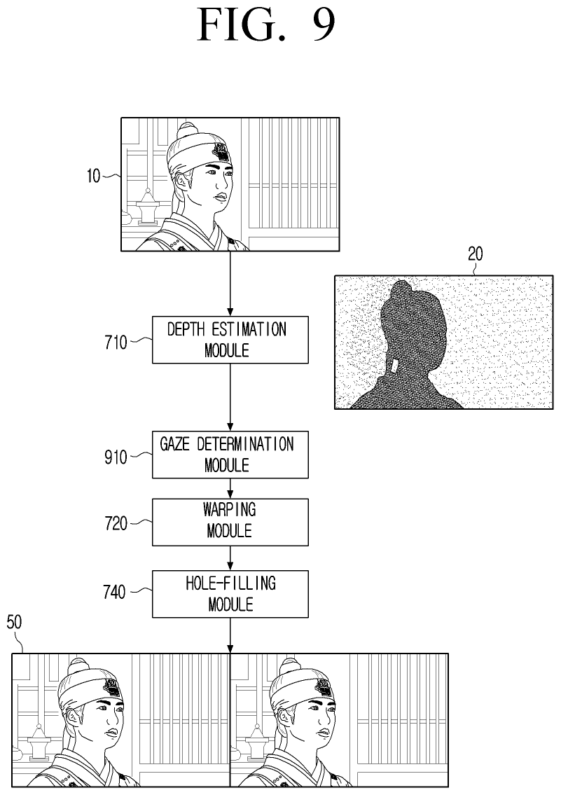

FIG. 8 and FIG. 9 are diagrams for illustrating a method for controlling an electronic apparatus according to an embodiment.

Among the operations illustrated in FIG. 8, exemplary embodiments may include operations overlapping with the operations illustrated in FIG. 6, and accordingly detailed explanation will be omitted.

According to FIG. 8, in operation 810, the electronic apparatus 100 may obtain a depth map corresponding to an input image.

In operation 820, the electronic apparatus 100 may identify a plurality of object regions included in the input image based on the depth map. According to an embodiment, the processor 130 may obtain a depth map by using the depth estimation module 710, and identify object regions included in the input image, e.g., a foreground region and a background region.

In operation 830, the electronic apparatus 100 may identify boundary regions and reference regions in the depth map based on the plurality of object regions identified in the depth map. According to an embodiment, the processor 130 may identify the boundary regions and the reference regions in the depth map based on the plurality of object regions identified in the depth map by using the depth estimation module 710. However, identification of the boundary regions and the reference regions in the depth map may also be performed through the view determination module 910.

For example, if a foreground region and a background region are identified in one scene wherein there are two regions with adjoining boundary regions, the depth estimation module 710 may identify the reference region included in the background region. The reference region may be a region for filling the hole regions in the warping image.

In operation 840, the electronic apparatus 100 may identify at least one of the boundary complexity, the sizes of the holes corresponding to the boundary regions, or the complexity of the reference regions in the depth map. According to an embodiment, the processor 130 may identify at least one of the boundary complexity, the sizes of the holes corresponding to the boundary regions, or the complexity of the reference regions in the depth map by using the view determination module 910.

According to an embodiment, the electronic apparatus 100 may determine, estimate, or assume the sizes of the holes corresponding to the boundary regions based on gap information for the boundary regions in the depth map.

According to an embodiment, the electronic apparatus 100 may identify the complexity of a reference region based on at least one of texture information or edge information corresponding to the reference region.

In operation 850, the electronic apparatus 100 may identify a view where the hole filling complexity is relatively low from among the right eye view or the left eye view based on at least one of the boundary complexity, the sizes of the holes corresponding to the boundary regions, or the complexity of the reference regions identified in the depth map. According to an embodiment, the processor 130 may identify a view where the hole filling complexity is relatively low from among the right eye view or the left eye view by using the view determination module 910.

In operation 860, the electronic apparatus 100 may obtain a novel view image based on the identified view. According to an embodiment, the processor 130 may obtain a warping image based on the identified view by using the warping module 720, and obtain a novel view image by performing hole filling for the warping image that went through warping processing by using the hole filling module 740.

Meanwhile, in FIG. 8, the order was mapped to all steps for the convenience of explanation, but it is obvious that the order of steps that are not related to an order or that can be performed in parallel, etc. is not necessarily limited to the order.

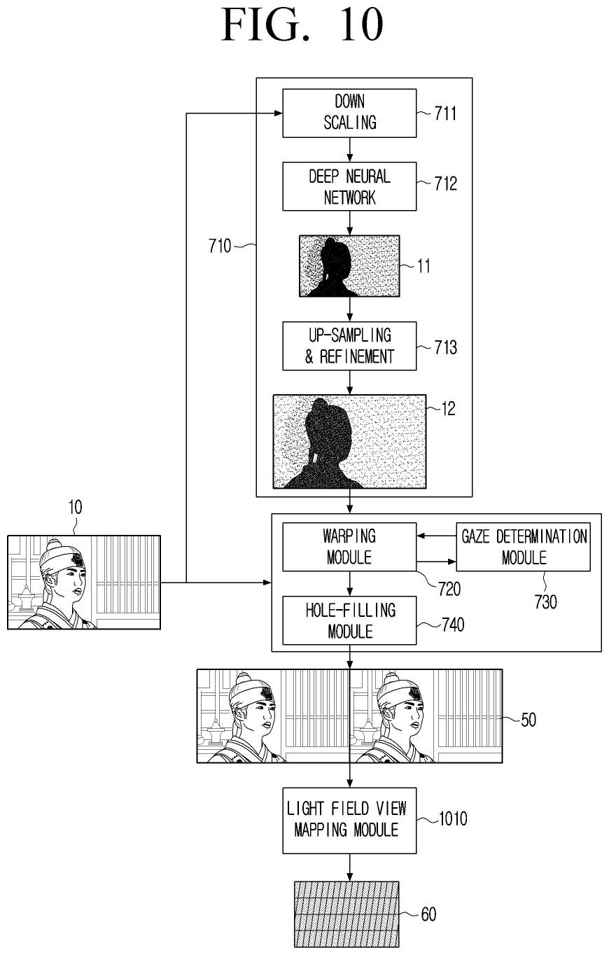

FIG. 10 is a diagram for illustrating in detail a method of providing a 3D image according to an embodiment.

Among the components illustrated in FIG. 10, regarding components overlapping with the components illustrated in FIG. 7, detailed explanation will be omitted. Also, FIG. 10 illustrates the detailed configurations of the modules illustrated in FIG. 7, but it is obvious that the detailed configurations of the modules overlapping with the modules illustrated in FIG. 7 among the modules illustrated in FIG. 9 can be implemented to be similar.

According to FIG. 10, the depth estimation module 710 may include a downscaling module 711, a deep neural network model module 712, and an upsampling and purification module 713.

The downscaling module 711 may downscale (or downsample) an input image 10. According to an embodiment, the downscaling module 711 may obtain a downscaled image by filtering the input image 10 by applying the filter to the input image 10. Here, filtering the input image 10 may mean performing weighted sum of filter information to the input image 10. For example, as a downscaling method, at least one interpolation method among bilinear interpolation, nearest neighbor interpolation, bicubic interpolation, deconvolution interpolation, subpixel convolution interpolation, polyphase interpolation, trilinear interpolation, linear interpolation can be used.

The deep neural network model 712 may obtain a depth map 11 based on the downscaled image. According to an embodiment, the deep neural network model 712 may obtain the depth map 11 by inputting the downscaled image into a deep neural network.

The upsampling and purification module 713 may upsample (or upscale) and purify the depth map 11 obtained from the deep neural network model 712. For example, the upsampling and purification module 713 may upsample the depth map 11 by using a method identical/similar to the downscaling method.

According to an embodiment, the upsampling and purification module 713 may perform depth map purification based on density information of objects included in the depth map, the thicknesses of the objects, etc. For example, the upsampling and purification module 713 may perform depth map purification through purification based on a central value filter and/or purification based on comparison of color information. The purification based on a central value filter is a method of allotting a central value of depth values of pixels existing in the Windows as an output value. In this process, pixels in the depth boundary regions may be excluded. The purification based on a central value filter may obtain a stable depth boundary, and is effective for alleviating an inversion phenomenon of a depth value generated in a depth boundary. The purification based on comparison of color information is a method of allotting a depth value of a pixel having the most similar color value to a pixel subject to purification among the pixels in the Windows as an output value. In this process, pixels in the depth boundary regions may be excluded from comparison. According to an embodiment, the degree of similarity of color values may be calculated as a Euclidean distance between a pixel subject to purification and a pixel subject to comparison. The purification method based on comparison of color information enables precise depth map purification even when objects are thin.

The warping module 720 may perform warping processing based on the depth map 12 obtained through the upsampling and purification module 713.

The hole filling module 740 may obtain a binocular image 50 including at least one novel view image by performing hole filling for the hole regions included in the warping image.

A light field view mapping module may obtain an output image 60 to be displayed on the display 130 based on the binocular image 50. According to an embodiment, the output image 60 may be a side by side image. The side by side image is an image that is provided as a left eye image and a right eye image are respectively sub-sampled by ½ in a horizontal direction, and in the output image 60, the left eye image and the right eye image 50 may be alternatingly arranged. For example, as illustrated in FIG. 3, the output image 60 where the left eye image and the right eye image 1, 2 are sequentially arranged may be provided.

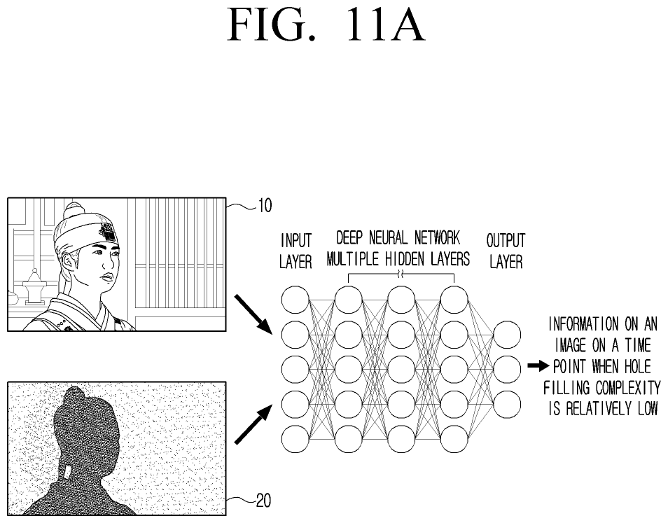

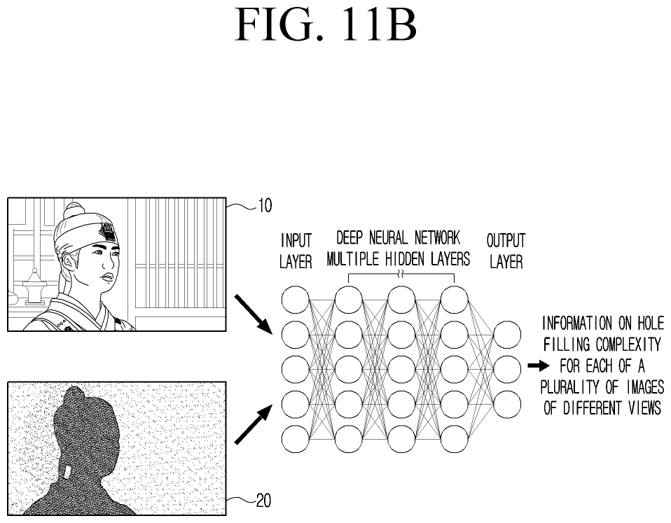

FIG. 11A and FIG. 11B are diagrams for illustrating a method of obtaining information by using an artificial intelligence model according to an embodiment.

According to an embodiment, the electronic apparatus 100 may obtain information on an image of a view where hole filling complexity is relatively low among a plurality of images of different views by inputting the input image 10 and the depth map 20 into a trained artificial intelligence model, as illustrated in FIG. 11A. For example, the electronic apparatus 100 may obtain information on an image of a view where hole filling complexity is relatively low from among a left eye image and a right eye image from the trained artificial intelligence model.

According to an embodiment, the electronic apparatus 100 may obtain information on the hole filling complexity for each of the plurality of images of different views by inputting the input image 10 and the depth map 20 into the trained artificial intelligence model, as illustrated in FIG. 11B. For example, the electronic apparatus 100 may obtain information on the hole filling complexity for each of the left eye image and the right eye image from the trained artificial intelligence model.

Here, the feature that the artificial intelligence model is trained means that a basic artificial intelligence model (e.g., an artificial intelligence model including any random parameters) is trained by using a plurality of training data by a learning algorithm, and predefined operation rules or an artificial intelligence model set to perform a desired characteristic (or, purpose) is thereby made. Such learning may be performed through a separate server and/or system, but is not limited thereto, and it may be performed in the electronic apparatus 100. As examples of learning algorithms, there are supervised learning, unsupervised learning, semi-supervised learning, or reinforcement learning, but learning algorithms are not limited to the aforementioned examples.

Here, the artificial intelligence model may be implemented as, for example, a convolutional neural network (CNN), a recurrent neural network (RNN), a restricted Boltzmann Machine (RBM), a deep belief network (DBN), a bidirectional recurrent deep neural network (BRDNN), or deep Q-networks, etc., but is not limited thereto.

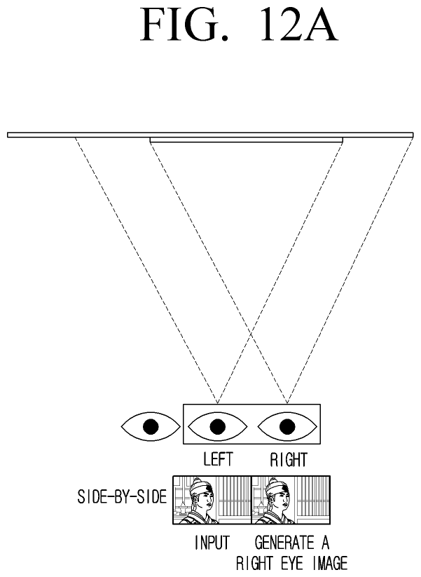

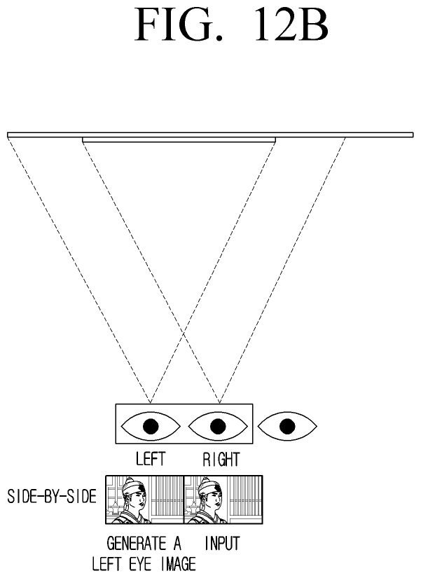

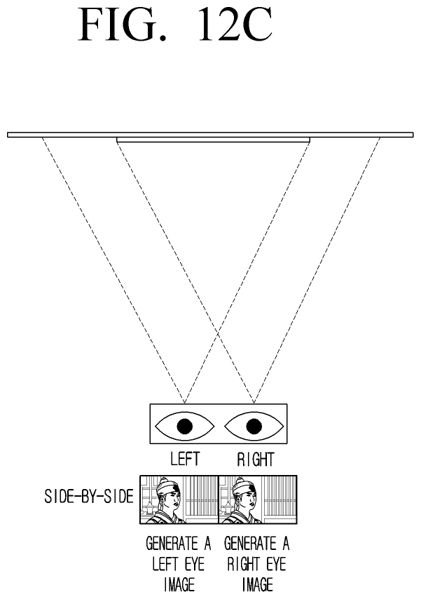

FIG. 12A to FIG. 12C are diagrams for illustrating a method of generating an image of a novel view.

According to an embodiment, the electronic apparatus 100 may obtain a novel view mage based on the same view in a unit of a predetermined frame section. For example, the unit of the predetermined frame section may include one frame unit or one scene unit. According to an embodiment, the electronic apparatus 100 may identify a time point effective for (or a time point advantageous for) hole filing in one frame unit, and generate a novel view image based on the identified view. According to an embodiment, the electronic apparatus 100 may identify a time point effective for hole filing in a scene unit, and generate a novel view image based on the identified view.

According to FIG. 12A, if it is determined that generating a right eye image by using an input image as a left eye image is advantageous for hole filling, the electronic apparatus 100 may generate the right eye image as a novel view image based on the input image.

According to FIG. 12B, if it is determined that generating a left eye image by using an input image as a right eye image is advantageous for hole filling, the electronic apparatus 100 may generate the left eye image as a novel view image based on the input image.

According to FIG. 12C, if it is determined that generating both of a right eye image and a left eye image based on an input image is effective for hole filling, the electronic apparatus 100 may generate the left eye image and the right eye image as a novel view image based on the input image.

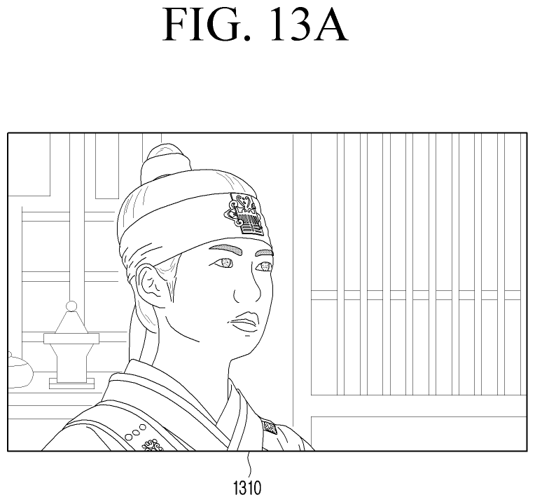

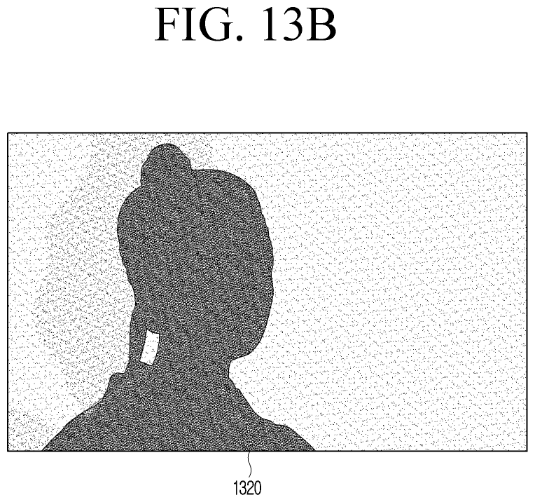

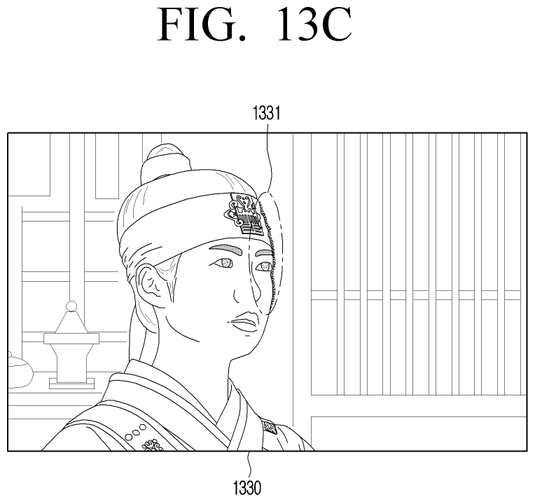

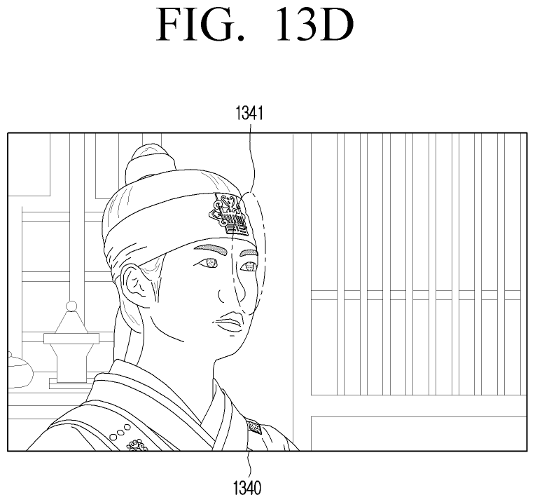

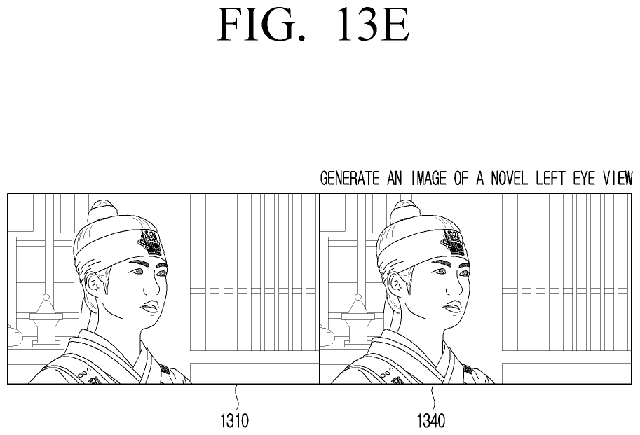

FIG. 13A to FIG. 13E are diagrams for illustrating a method of generating an image of a novel view according to an embodiment.

According to an embodiment, if an input image 1310 as illustrated in FIG. 13A is obtained, the electronic apparatus 100 may obtain a depth map 1320 as illustrated in FIG. 13B based on the input image 1310.

According to an embodiment, the electronic apparatus 100 may obtain a first warping image 1330 corresponding to a right eye view as illustrated in FIG. 13C, and identify hole filling complexity based on the location of the hole region 1331 included in the first warping image 1330 and the size of the hole region 1331. For example, the electronic apparatus 100 may identify the size of the hole region 1331 based on the number of pixels corresponding to the hole region 1331 included in the first warping image 1330. For instance, the electronic apparatus 100 may identify a reference region based on the location of the hole region 1331, and identify complexity of the reference region. For example, the electronic apparatus 100 may identify hole filling complexity for the hole region 1331 based on the size of the hole region 1331 and the complexity of the reference region.

According to an embodiment, the electronic apparatus 100 may obtain a second warping image 1340 corresponding to the left eye view as illustrated in FIG. 13D, and identify hole filling complexity based on the locations of the hole regions included in the second warping image 1340 and the sizes of the hole regions.

According to FIG. 13C and FIG. 13D, it can be identified that in the first warping image 1330 corresponding to the right eye view, a hole region 1331 greater than or equal to a specific size is generated, but in the second warping image 1340 corresponding to the left eye view, a hole region is almost not generated 1341. In this case, the electronic apparatus 100 may identify the left eye view corresponding to the second warping image 1340 effective for hole filling as a novel view, and identify the left eye image as a novel view image. For the convenience of explanation, a hole region was not generated in the second warping image 1340 illustrated in FIG. 13D, and thus the image is identical to the left eye image.

According to FIG. 13E, the electronic apparatus 100 may obtain a binocular image based on the input image 1310 and the left eye image 1340 which is a novel view image. In FIG. 13E, for the convenience of explanation, a hole region was not generated in the second warping image 1340 illustrated in FIG. 13D, and thus the image is identical to the left eye image.

Meanwhile, in FIG. 13A to FIG. 13E, it was explained that hole filling complexity is obtained through warping processing, for the convenience of explanation, but it is obvious that hole filling complexity can be obtained through analysis of the depth map 1320 before warping processing.

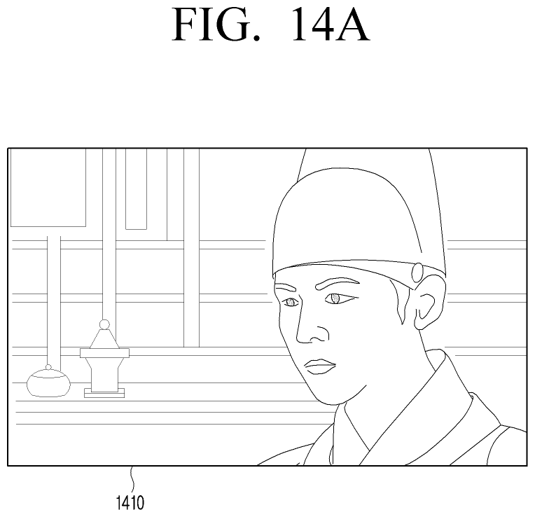

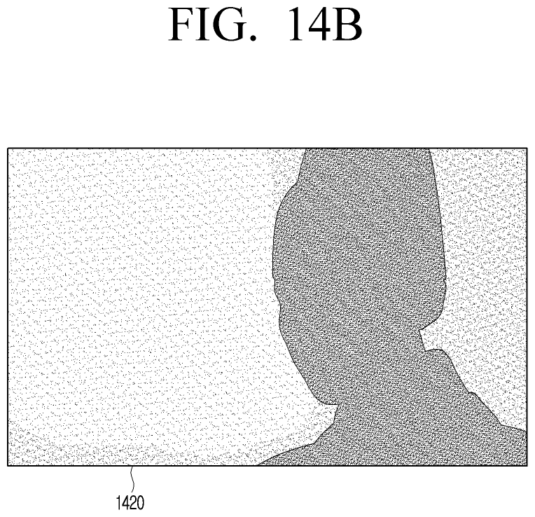

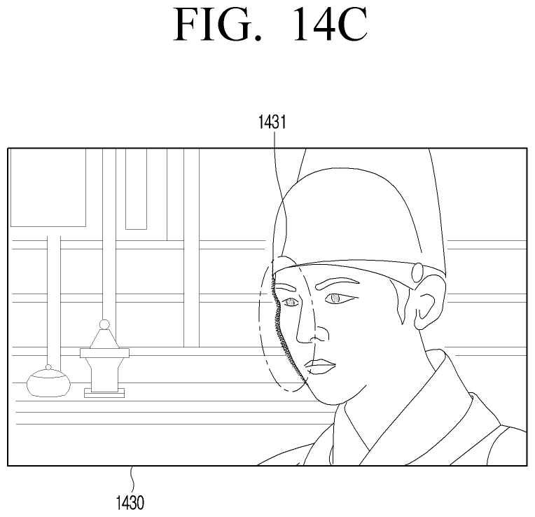

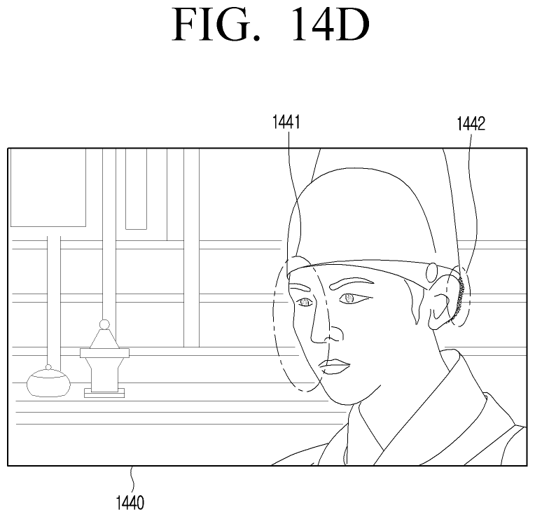

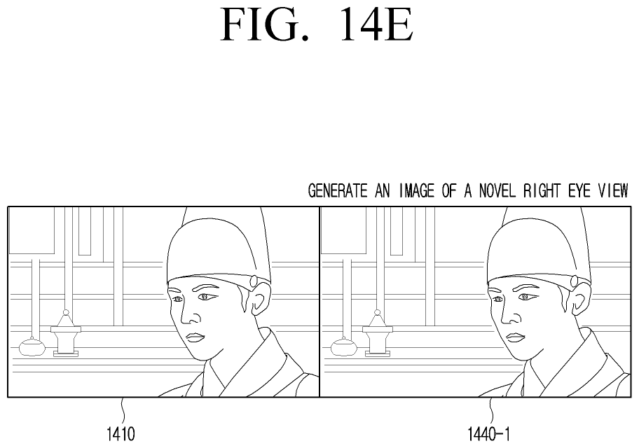

FIG. 14A to FIG. 14E are diagrams for illustrating a method of generating an image of a novel view according to an embodiment.

According to an embodiment, if an input image 1410 as illustrated in FIG. 14A is obtained, the electronic apparatus 100 may obtain a depth map 1420 as illustrated in FIG. 14B based on the input image 1410.

According to an embodiment, the electronic apparatus 100 may obtain a third warping image 1430 corresponding to the left eye view as illustrated in FIG. 14C, and identify hole filling complexity based on the location of the hole region 1431 and the size of the hole region 1431 included in the third warping image 1430. For example, the electronic apparatus 100 may identify hole filling complexity for the hole region 1431 based on the size of the hole region 1431 and the complexity of the reference region.

According to an embodiment, the electronic apparatus 100 may obtain a fourth warping image 1440 corresponding to the right eye view as illustrated in FIG. 14D, and identify hole filling complexity based on the location of the hole region 1441 included in the second warping image 1440 and the size of the hole region 1441.

According to FIG. 14C and FIG. 14D, it can be identified that in the third warping image 1430 corresponding to the left eye view, a hole region 1431 greater than or equal to a specific size is generated, but in the fourth warping image 1440 corresponding to the right eye view, a hole region is almost not generated in the region 1441 corresponding to the third warping image 1430, but a hole is generated in another region 1442. In this case, as the size of the hole region 1442 generated in the fourth warping image 1440 is relatively smaller than the hole region 1431 generated in the third warping image 1430, the electronic apparatus 100 may identify the right eye view corresponding to the fourth warping image 1440 effective for hole filling as a novel view, and identify the right eye image as the novel view image.

According to FIG. 14E, the electronic apparatus 100 may obtain a binocular image based on the input image 1410 and the right eye image 1440-1 which is a novel view image. For example, the electronic apparatus 100 may obtain the right eye image 1440-1 by filling the hole region 1442 in the fourth warping image 1440.

Meanwhile, in FIG. 14A to FIG. 14E, it was explained that hole filling complexity is obtained through warping processing, for the convenience of explanation, but it is obvious that hole filling complexity can be obtained through analysis of the depth map 1420 before warping processing.

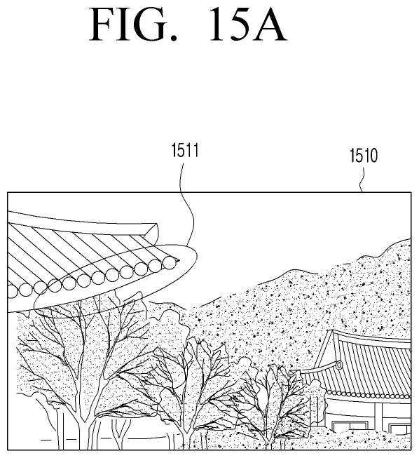

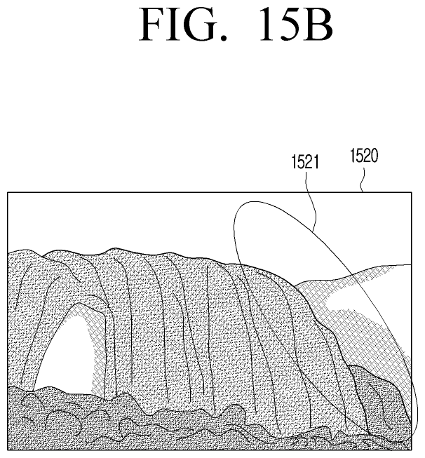

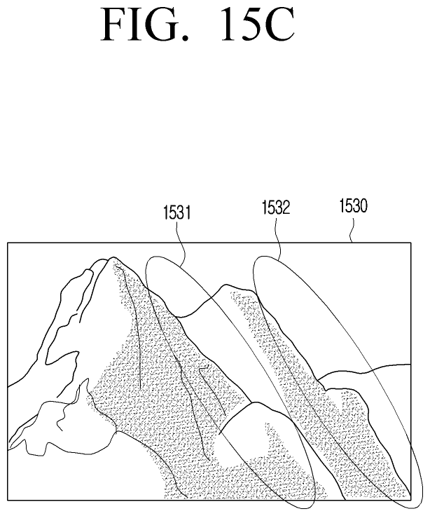

FIG. 15A to FIG. 15C are diagrams for illustrating a method of generating an image of a novel view according to an embodiment.

According to an embodiment, in case it is effective for hole filling to generate a left eye image by using an input image as a right eye view, the electronic apparatus 100 may generate the left eye image as a novel view image. Accordingly, the electronic apparatus 100 may obtain a binocular image including the input image and the left eye image.

For example, in the case of FIG. 15A, FIG. 15B, and FIG. 15C, if a left eye image is generated based on input images 1510, 1520, 1530, the sizes of the hole regions 1511, 1521, 1531, 1532 are very small, and the backgrounds are simple and the boundaries are also simple, and thus a left eye image can be generated with few side effects. Accordingly, the electronic apparatus 100 may obtain a binocular image by generating a left eye image by using the input image as the right eye view.

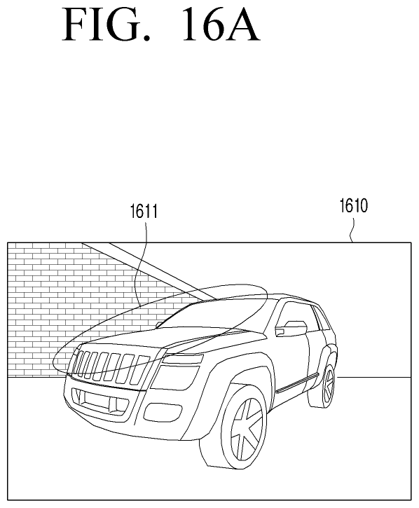

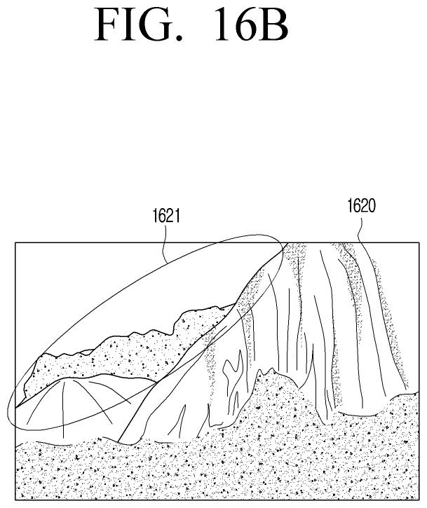

FIG. 16A and FIG. 16B are diagrams for illustrating a method of generating an image of a novel view according to an embodiment.

According to an embodiment, in case it is effective for hole filling to generate a right eye image by using an input image as a left eye view, the electronic apparatus 100 may generate the right eye image as a novel view image. Accordingly, the electronic apparatus 100 may obtain a binocular image including the input image and the right eye image.

For example, in the case of FIG. 16A and FIG. 16B, if a right eye image is generated based on input images 1610, 1620, the sizes of the hole regions 1611, 1612 are very small, and the backgrounds are simple and the boundaries are also simple, and thus a right eye image can be generated with few side effects. Accordingly, the electronic apparatus 100 may obtain a binocular image by generating a right eye image by using the input image as the left eye view.

According to the aforementioned various embodiments, a natural 3D image can be obtained by generating an image on a time point where the hole sizes are small and hole filling is easy as a novel view image according to the characteristic of the image.

Meanwhile, methods according to the aforementioned various embodiments of the disclosure may be implemented just with software upgrade, or hardware upgrade for a conventional electronic apparatus and/or a server.

Also, the aforementioned various embodiments of the disclosure may be performed through an embedded server provided on an electronic apparatus, or an external server of an electronic apparatus.

Meanwhile, according to an embodiment of the disclosure, the aforementioned various embodiments may be implemented as software including instructions stored in machine-readable storage media, which can be read by machines (e.g.: computers). The machines refer to apparatuses that call instructions stored in a storage medium, and can operate according to the called instructions, and the apparatuses may include an electronic apparatus according to the aforementioned embodiments (e.g.: an electronic apparatus A). In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that the storage medium does not include signals, and is tangible, and the term does not distinguish whether data is stored semi-permanently or temporarily in a storage medium.

Also, according to an embodiment, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

In addition, each of the components (e.g.: a module or a program) according to the aforementioned various embodiments may consist of a singular object or a plurality of objects, and among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic apparatus comprising:
memory storing one or more instructions; and
at least one processor configured to execute the one or more instructions,
wherein the one or more instructions, when executed by the at least one processor, cause the electronic apparatus to:
based on a depth map corresponding to an input image, identify a plurality of object regions included in the input image,
identify hole-filling complexity for hole regions that are generated in boundary regions among the plurality of object regions,
identify a view of an image of a novel view based on the hole-filling complexity, and obtain the image of the novel view based on the view.

2. The electronic apparatus of claim 1, wherein the one or more instructions, when executed by the at least one processor, further cause the electronic apparatus to:
identify the hole-filling complexity for the hole regions based on at least one of: a complexity of the boundary regions, sizes of holes generated in the boundary regions, or a complexity of reference regions for filling the holes, and
obtain the image of the novel view based on a view for which the hole-filling complexity is relatively low from among a right eye view or a left eye view.

3. The electronic apparatus of claim 2, wherein the one or more instructions, when executed by the at least one processor, further cause the electronic apparatus to:
perform warping for at least one of a right eye image or a left eye image based on the depth map to generate a warped right eye image or a warped left eye image,
identify at least one of the complexity of the boundary regions, the sizes of the holes generated in the boundary regions, or the complexity of the reference regions from at least one of the warped right eye image or the warped left eye image, and
identify an image for which the hole-filling complexity is relatively low from among the right eye image or the left eye image as the image of the novel view.

4. The electronic apparatus of claim 2, wherein the one or more instructions, when executed by the at least one processor, further cause the electronic apparatus to:
identify the plurality of object regions in the depth map based on depth information,
identify the boundary regions and the reference regions in the depth map based on the plurality of object regions identified in the depth map,
identify at least one of: the complexity of the boundary regions, the sizes of the holes corresponding to the boundary regions, or the complexity of the reference regions in the depth map, and
identify the view for which the hole-filling complexity is relatively low from among the right eye view or the left eye view based on at least one of: the complexity of the boundary regions,
the sizes of the holes corresponding to the boundary regions, or the complexity of the reference regions identified in the depth map.

5. The electronic apparatus of claim 3, wherein the one or more instructions, when executed by the at least one processor, further cause the electronic apparatus to:
determine the sizes of the holes corresponding to the boundary regions based on information on gaps for the boundary regions in the depth map, or identify the sizes of the holes by counting the holes in an image generated by the warping.

6. The electronic apparatus of claim 2, wherein the one or more instructions, when executed by the at least one processor, further cause the electronic apparatus to:
identify the complexity of the reference regions based on at least one of texture information or edge information corresponding to respective reference regions.

7. The electronic apparatus of claim 1, wherein the one or more instructions, when executed by the at least one processor, further cause the electronic apparatus to:
obtain information on the image for which the hole-filling complexity is relatively low among a plurality of images of different points of view by inputting the input image and the depth map into a trained artificial intelligence model, or
obtain information on the hole-filling complexity for each of the plurality of images of the different points of view by inputting the input image and the depth map into the trained artificial intelligence model.

8. The electronic apparatus of claim 1, wherein the one or more instructions, when executed by the at least one processor, further cause the electronic apparatus to:
identify the image of the novel view based on a same view in a unit of a predetermined frame section, and
the unit of the predetermined frame section comprises one of: one frame unit or one scene unit.

9. The electronic apparatus of claim 8, wherein the one or more instructions, when executed by the at least one processor, further cause the electronic apparatus to:
generate the image of the novel view that smoothly changes among continuous frames through filtering when the image of the novel view is based on respective view identified for each of the one frame unit or the one scene unit.

10. The electronic apparatus of claim 1, wherein the electronic apparatus further comprises:
a display, and
the one or more instructions, when executed by the at least one processor, further cause the electronic apparatus to:
obtain an output image including a right eye output image based on the input image and the image of the novel view and a left eye output image based on the input image and the image of the novel view, and
provide the output image through the display.

11. A method for controlling an electronic apparatus, the method comprising:
based on a depth map corresponding to an input image, identifying a plurality of object regions included in the input image;
identifying hole-filling complexity for hole regions that are generated in boundary regions among the plurality of object regions; and
identifying a view of an image of a novel view based on the hole-filling complexity, and obtaining the image of the novel view based on the identified view.

12. The controlling method of claim 11, wherein the identifying the hole-filling complexity comprises:
identifying the hole-filling complexity for the hole regions based on at least one of: a complexity of the boundary regions, sizes of holes generated in the boundary regions, or complexity of reference regions for filling the holes, and
the obtaining the image of the novel view comprises:
obtaining the image of the novel view based on a view for which the hole-filling complexity is relatively low from among a right eye view or a left eye view.

13. The controlling method of claim 12,
wherein the identifying the hole-filling complexity comprises:
performing warping for at least one of a right eye image or a left eye image based on the depth map to generate a warped right eye image or a warped left eye image; and
identifying at least one of the complexity of the boundary regions, the sizes of the holes generated in the boundary regions, or the complexity of the reference regions from at least one of the right eye image or the left eye image generated in the warping process, and
the obtaining the image of the novel view comprises:
identifying an image for which the hole-filling complexity is relatively low from among the right eye image or the left eye image as the image of the novel view.

14. The controlling method of claim 12,
wherein the identifying the hole-filling complexity comprises:
identifying the plurality of object regions in the depth map based on depth information; and
identifying the boundary regions and the reference regions in the depth map based on the plurality of object regions identified in the depth map; and
identifying at least one of the complexity of the boundary regions, the sizes of the holes corresponding to the boundary regions, or the complexity of the reference regions in the depth map, and
the obtaining the image of the novel view comprises:
identifying the view for which the hole-filling complexity is relatively low from among the right eye view or the left eye view based on at least one of the complexity of the boundary regions, the sizes of the holes corresponding to the boundary regions, or the complexity of the reference regions identified in the depth map.

15. A non-transitory computer-readable medium storing computer instructions that, when executed by a processor of an electronic apparatus, cause the electronic apparatus to perform operations,
wherein the operations comprise:
based on a depth map corresponding to an input image, identifying a plurality of object regions included in the input image;
identifying hole-filling complexity for hole regions that are generated in boundary regions among the plurality of object regions; and
identifying a view of an image of a novel view based on the hole-filling complexity, and obtaining the image of the novel view based on the identified view.

16. The non-transitory computer-readable medium of claim 15,
wherein the operations further comprise:
identifying the hole-filling complexity for the hole regions based on at least one of: a complexity of the boundary regions, sizes of holes generated in the boundary regions, or a complexity of reference regions for filling the holes, and
obtaining the image of the novel view based on a view for which the hole-filling complexity is relatively low, wherein the view for which the hole-filling complexity is relatively low is one of a right eye view or a left eye view.

17. The non-transitory computer-readable medium of claim 16,
wherein the operations further comprise:
performing warping for at least one of a right eye image or a left eye image based on the depth map to generate a warped right eye image or a warped left eye image,
identifying at least one of: the complexity of the boundary regions, the sizes of the holes generated in the boundary regions, or the complexity of the reference regions, wherein the identification is performed with respect to at least one of the warped right eye image or the warped left eye image, and
identifying an image for which the hole-filling complexity is relatively low from among the right eye image or the left eye image as the image of the novel view.

18. The non-transitory computer-readable medium of claim 16,
wherein the operations further comprise:
identifying the plurality of object regions in the depth map based on depth information,
identifying the boundary regions and the reference regions in the depth map based on the plurality of object regions identified in the depth map,
identifying at least one of: the complexity of the boundary regions, the sizes of the holes corresponding to the boundary regions, or the complexity of the reference regions in the depth map, and
identifying the view for which the hole-filling complexity is relatively low based on at least one of: the complexity of the boundary regions, the sizes of the holes corresponding to the boundary regions, or the complexity of the reference regions identified in the depth map,
wherein the view for which the hole-filling complexity is relatively low is one of the right eye view or the left eye view.

19. The non-transitory computer-readable medium of claim 17,
wherein the operations further comprise:
determining the sizes of the holes corresponding to the boundary regions based on information on gaps for the boundary regions in the depth map, or
identifying the sizes of the holes by counting the holes in an image generated by the warping.

20. The non-transitory computer-readable medium of claim 16,
wherein the operations further comprise:
identifying the complexity of the reference regions based on at least one of texture information or edge information corresponding to respective reference regions.
